(19) United States
(12) Patent Application Publication
(10) Pub. No.: US 2019/0293036 A1
(43) Pub. Date: Sep. 26, 2019

(54) DIESEL FUEL FILTRATION AND FEED SYSTEM FOR GENERATOR

(71) Applicants: Alexander C. Marcus, Lovettsville, VA (US); Andrew R. Holmberg, Broadlands, VA (US)

(72) Inventors: Alexander C. Marcus, Lovettsville, VA (US); Andrew R. Holmberg, Broadlands, VA (US)

(73) Assignee: ENIRONMENTAL SOLUTIONS INTERNATIONAL, INC., ASHBURN, VA (US)

(21) Appl. No.: 16/501,297

(22) Filed: Mar. 22, 2019

Related U.S. Application Data
(60) Provisional application No. 62/647,587, filed on Mar. 23, 2018.

(51) Int. Cl. F02M 37/50; F02M 37/24; B01D 35/00; B01D 37/04; F02B 63/04

(52) U.S. Cl. CPC F02M 37/50; F02M 37/24; B01D 2201/56; B01D 37/045; F02B 63/04; B01D 35/005

(57) ABSTRACT

A fuel tank assembly for an electrical generator constructed with a double walled tank with side walls, a front wall mounted to the side walls, a rear wall mounted to the side walls, a bottom wall mounted to the side, front and rear walls and a top wall mounted to the side, front and rear walls. The side walls, front and rear wall and bottom wall are constructed with a spaced outer wall and an inner wall defining an enclosed central chamber adapted to receive diesel fuel; the inner bottom wall defining at least two angled sections extending inward into the central chamber toward the outer bottom wall. A skid assembly is mounted to the outer bottom wall to provide support for the fuel tank. A filtration assembly is mounted to the skid assembly and communicates with a central chamber of the tank and a microprocessor is mounted to the fuel tank, the microprocessor being connected to the sensors and the filtration assembly to receive data from the sensors and filtration assembly and transmit the data to a user.

### RELATED APPLICATIONS

This is a utility application claiming priority and the benefits of U.S. Provisional Patent Application No. 62/647,587 filed Mar. 23, 2018.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

### 1. Field of Invention

The present invention is directed generally to electrical power supply and more particularly to an improved generator fuel tank module for diesel fuel supply to multiple or single generators coordinated together as a unit for back-up power generation to provide power needs in case of an electrical utility power failure, grid power shortages, grid low voltage and grid reactive power needs.

### 2. Description of the Prior Art

Power production from the conversion of mechanical energy to electrical energy is well known and utilized to meet a variety of power load demands. In today's expanding use of cloud computing, data storage and in other areas such as hospital and emergency facilities it is critical that electrical power be provided at a constant voltage and consistency regardless of weather, power grid load or other extenuating circumstances.

One problem with the use of redundant generators is the inefficient fuel demand and fuel supply. Currently, there is considerable expense and unnecessary fuel consumption required to operate redundant generators. Furthermore, operating multiple large hydrocarbon powered engines to produce electrical energy produces considerable toxic fumes, including nitrogen dioxide and/or sulfur dioxide. This by-product of on-site energy production is limited by federal mandate and thus presents both safety and design concerns as well as environmental reporting requirements to state and federal authorities.

Another problem inherent in storing diesel fuel is fuel contamination that leads to costly service and repairs. Fuel contaminants include water, oxides, microorganisms, dust, dirt, and other natural contaminants found in all diesel fuel. Another source of contamination is algae. Approximately, 90% of generator failure is directly connected to the fuel used by the generator. Diesel fuel has an average storage life of about 6 months before microbiological contamination becomes a serious problem. Microorganisms, such as algae, bacteria, and fungus, feed on the oil and use the water collected in the fuel for their oxygen supply. The use of cracked diesel fuel has led to an increase in the amount of water collected in the tank while the use of low-sulfur diesel fuel typically produced in the United States from United States oil and natural gas deposits promotes the growth of algae. Reducing the sulfur in the fuel also reduces the aromatic content of the fuel. Microorganisms use these aromatics as a source of food, and a reduction in aromatics forces the microorganisms to turn to other food supplies. Microorganisms growing in a fuel supply can lead to significant dollar damage to a fuel tank and the generator(s) powered by the fuel tank as well as significant generator downtime. The spread of the problem is very serious considering that a clean system can be contaminated by using a fuel nozzle connected to a contaminated tank. Clean diesel fuel can also easily become contaminated during transportation and storage. As processed fuel is transferred from the refinery by rail or pipeline to the consumer, it may be stored in numerous different storage tanks of varying ages before reaching the final consumer. Contaminants should be removed immediately before the fuel enters the generator's filter system, so as not to damage the system. Generators demand very high quality fuel entering the cylinders in order to operate effectively and efficiently.

The contaminated fuel problem also results in a build-up of a sludge or slime in the bottom of a fuel tank. The build-up of sludge can lead to the clogging of fuel filters and fuel system components, such as fuel injectors and pumps. Water in a fuel tank can also lead to serious problems, and algae clinging to the inside of a fuel tank will hold onto the water inside of a tank, making it difficult to drain the water out of the tank. Water is continuously formed in a fuel tank as a result of condensation when a tank is not kept at full capacity. The process occurs both day and night. Water in a steel tank not only supplies the microorganisms with oxygen, but also may lead to rust problems and tank decay, causing further contamination problems.

The prior art has attempted to solve these problems but has been unable to provide a solution to same.

U.S. Pat. No. 4,275,382 issued Jun. 23, 1981 discloses an apparatus for determining the level of liquid in a storage tank using a plurality of sensors (read switches) at varying heights in the storage tank acting to indicate the presence of the liquid level at a given height. A microprocessor receives signals from the sensors and translates such signals into liquid level height. The microprocessor stores information from the controller for future use in memory and has a display system to receive signals from the sensors as to height and temperature and provide a visual display of the liquid level height and temperature. A further embodiment is disclosed in which the controller sends out signals to alter the status of one or more pumps, valves and the like.

U.S. Pat. No. 9,506,795 issued Nov. 29, 2016 discloses a tank level monitoring system with wireless transmission capability. The monitoring system includes a wireless tank monitor for level sensing connected to one or more float level sensors. The system regularly measures the level of fluid in a tank, but may change the measurement rate based upon signals from the float switch. This system actively monitors conditions of a tank and alerts a user when conditions exceed a predetermined parameter.

U.S. Patent Application Publication Number 2013/0181829 published on Jul. 18, 2013 discloses a system for measuring and reporting changing levels of liquids in a storage tank and includes a sensing device having a fluid level sensor, an accelerometer, a wireless transceiver, and a microcontroller for detecting the volume of liquid in the storage tank and sending an alert message if the volume of liquid in the storage tank has changed from a previous volume by a threshold amount. The system also includes a central tracking computer having a tracking database and is interfaced to the Internet, and a master control unit attached to the storage tank.

U.S. Patent Application Publication Number 2013/0293388 published on Nov. 7, 2013 discloses a system, apparatus and method for monitoring the status and use of an LP fuel tank using cellular communication technology. The system includes a sensor unit communicatively connected to a storage tank, the sensor unit measuring the level of fluid in the storage tank and transmitting fluid level data externally via a cellular data communication link. A remote host unit is disposed remotely from the storage tank, the host unit receiving fluid level data from the sensor unit via the cellular data communication link, and a base unit is disposed in the vicinity of the storage tank by a user, the base unit receiving fluid level data from the sensor unit.

U.S. Pat. No. 9,371,774 issued Jun. 21, 2016 discloses a fully automated emergency generator fuel oil system with plurality of emergency generator fuel oil system components. The system has a plurality of sensors continuously monitoring the physical status of the system components, and a master control panel is in operative communication with the plurality of sensors to interpret signals received from the plurality of sensors to determine if an event has occurred, namely, an event indicating the physical status of one or more of the system components, and when such event has occurred, the master control panel issues one or more instructions responsive to the event that control the function of one or more of the system components.

U.S. Pat. No. 9,321,467 issued Apr. 26, 2016 discloses a fuel assembly and a method of providing fuel to generators for the electric traction motors of a locomotive. The fuel assembly includes a frame, a first fuel storage tank sized to fit within the frame having fuel contained therein and an electronic fuel control assembly configured to regulate delivery of the gaseous fuel in the fuel storage tank to an external power unit. The fuel control assembly includes a microprocessor and a first fuel assembly electronic memory module having stored thereon identifying information by the interchangeable fuel assembly.

U.S. Patent Application Publication Number 2008/0128029 published Jun. 5, 2008 discloses a method directed toward ensuring backup generator fuel availability. The method includes, receiving natural gas at a local backup power generation site via a pipeline, compressing the natural gas and then containing the natural gas in compressed form until needed by the generator pursuant to a power outage or reduction.

U.S. Pat. No. 6,520,124 issued Feb. 18, 2003 is directed toward a double-walled tank for a generator set including an integral mounting assembly. The tank is formed of an outer basin having an open top, a bottom wall and a number of side walls that define an interior within the basin and form the exterior of the tank. An enclosed inner member having a top panel, a bottom panel and a number of side walls connecting the top and bottom panels is attached within the interior of the basin and provides a double-walled construction that serves to retain fuel within the tank when the external walls of the tank are damaged. An integral mounting assembly is attached to and extends across the basin over the inner member between the side walls of the basin and is configured to receive and support a generator, engine, and radiator to form a complete generator set.

What is needed in the industry is a fuel supply system and method that eliminates the need and cost of toxic biocide treatments, costly tank cleanings, exposure to and accidents from hazardous biocides, fuel starvation due to algae and bacteria growth, and equipment malfunction.

Also there is current need for a system and diesel fuel treatment method that reduces maintenance costs and downtime and protects machine components.

What is also needed is a system and diesel fuel treatment that reverses or precludes the process of sludge build-up, improves generator combustion, saves fuel, reduces carbon deposits, and reduces harmful emissions.

However, due to the increased attention given to environmental concerns, particularly with respect to those industries utilizing highly hazardous materials such as the heavy hydrocarbon fuels utilized with generator sets which are used in cloud server facilities, the single-walled construction of most generator set tanks is not adequate to ensure that the fuels contained within these tanks will not leak excessively and cause serious environmental damage if the exterior of the tank is damaged.

Therefore, it is desirable to develop a generator fuel tank which can be immediately transported in its entirety and placed into service. The tank should include a double-walled construction that minimizes and/or eliminates any leakage of fuel from the tank due to damage caused to the exterior of the tank. The generator fuel tank should also include an integral mounting arrangement such that once the tank has been moved to the generator site, the respective components of the generator may be mounted directly to the tank.

There is also a need to monitor the fuel levels in the tank to enable ultimate fuel levels to be maintained cutting down bacteria growth and to monitor the fuel quality of new fuel being deported into the generator supply tank.

The present invention overcomes these problems and current problems and deficiencies are solved by this invention in the manner described below.

### SUMMARY OF THE INVENTION

The present invention is directed to a diesel supply double walled skid mounted day tank assembly for use with generators. The inventive day tank is equipped with a redundant filtration and consumption monitoring system and is provided with a local microprocessor, controls and sensors to maintain preset day tank fuel levels and integrate with fuel transfer system. The fuel tank assembly microprocessor networks with a central control panel mounted on the tank allowing communication with the facility's building management system.

It is an object of this invention to provide local fuel storage and supply, redundant fuel filtration, fuel consumption monitoring and reporting of No. 2 diesel fuel including diesel fuels with bio-content blends.

It is another object of the invention to provide an automatic portable fuel day tank for a generator equipped with a redundant filtration and consumption monitoring system which can be drop shipped and added to existing installations or added to installations as additional generator power is needed.

It is yet another object of the invention to provide a portable day tank for a generator provided with double walls and a sloping floor to carry sludge and contaminants along the tank floor to a designated location in the tank for easy removal of the same.

It is still another object of the invention to utilize a microprocessor with a day tank to store fuel data, fuel quality data and fuel contamination data and generate usage and environmental reports.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended FIGS. 1-13, in which:

FIG. 1 is a perspective front and side view of the present generator fuel tank assembly invention;

FIG. 2 is a perspective rear and opposite side view of the present generator fuel tank assembly invention shown in FIG. 1;

FIG. 3 is a perspective rear and opposite side view of the generator fuel tank invention shown in FIG. 2;

FIG. 4 is a phantom side view of the fuel tank wall structure with the front and rear walls, fuel chamber and internal tubing being shown in broken lines;

FIG. 5 is a phantom front view of the fuel tank wall structure with the inner side walls, fuel chamber and internal tubing being shown in broken lines;

FIG. 6 is a front elevational view of the fuel tank invention shown in FIG. 1;

FIG. 7 is a side elevational view of the fuel tank invention shown in FIG. 6;

FIG. 8 is an opposite side elevational view from FIG. 7 of the fuel tank invention shown in FIG. 6;

FIG. 9 is a top plan view of the fuel tank invention shown in FIG. 6;

FIG. 10 is a rear elevational view of the fuel tank invention shown in FIG. 6;

FIG. 11 is a top plan view of the fuel tank invention showing the ports in the top panel;

FIG. 12 is an enlarged front elevational view of the control panel of the fuel tank invention shown in FIG. 6; and

FIG. 13 is an enlarged front elevational view of the filtration assembly of the fuel tank invention shown in FIG. 1.

### DESCRIPTION OF THE INVENTION

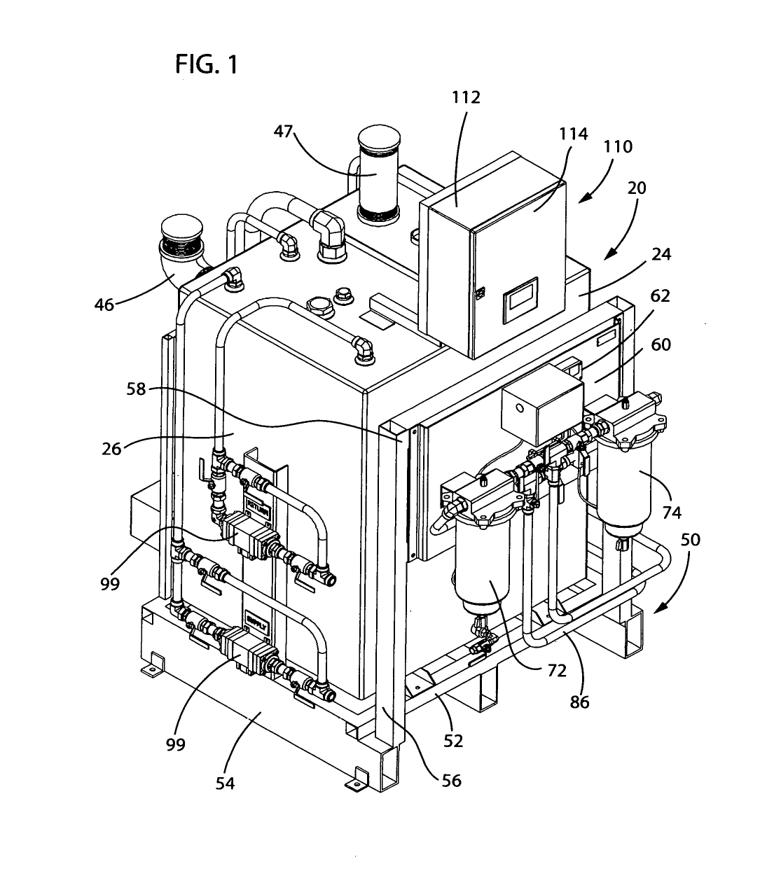

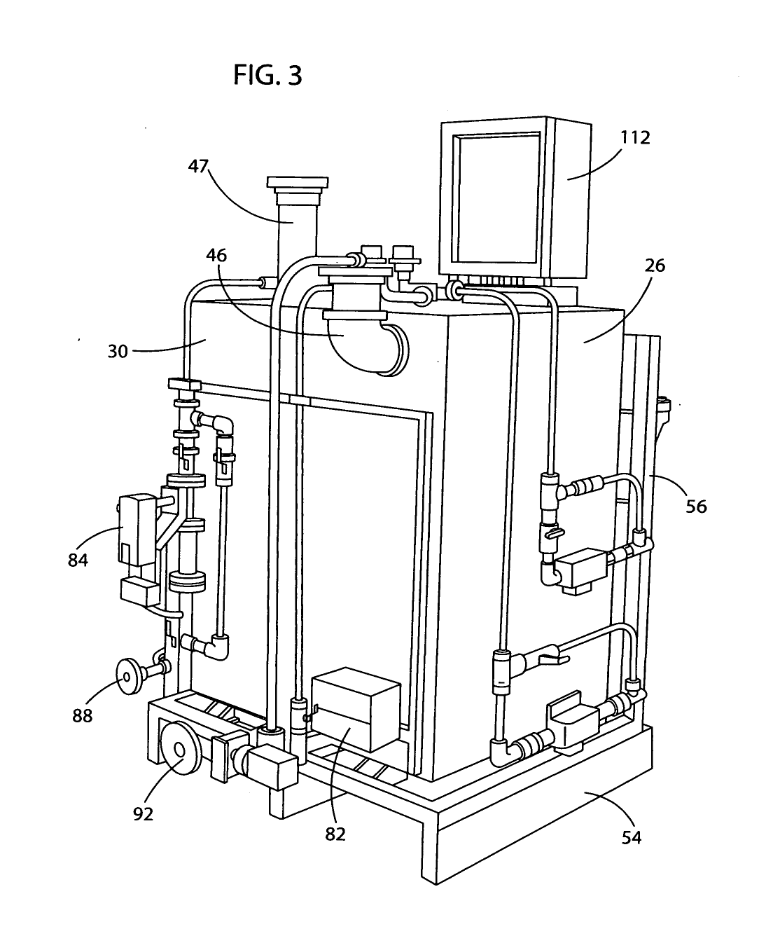

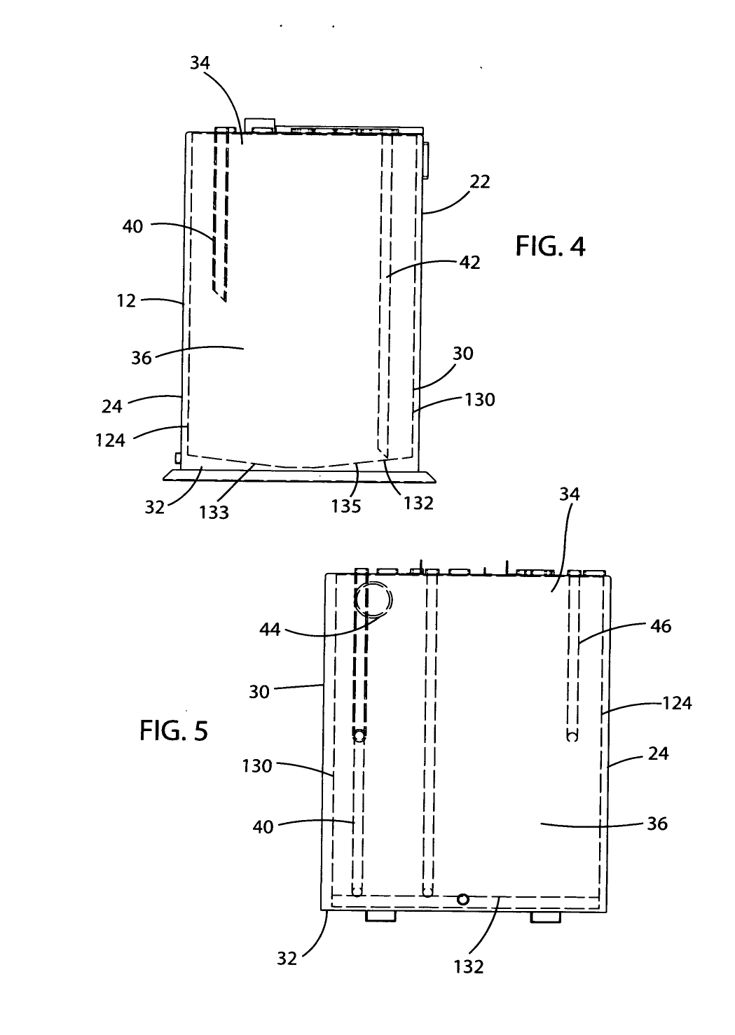

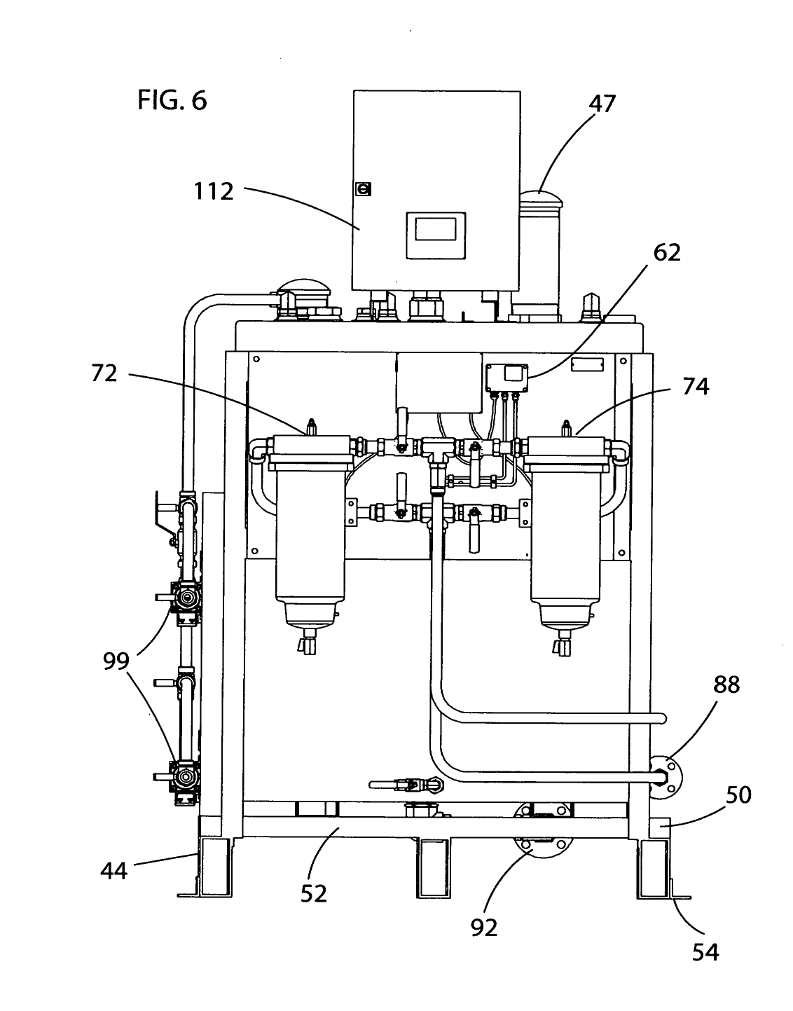

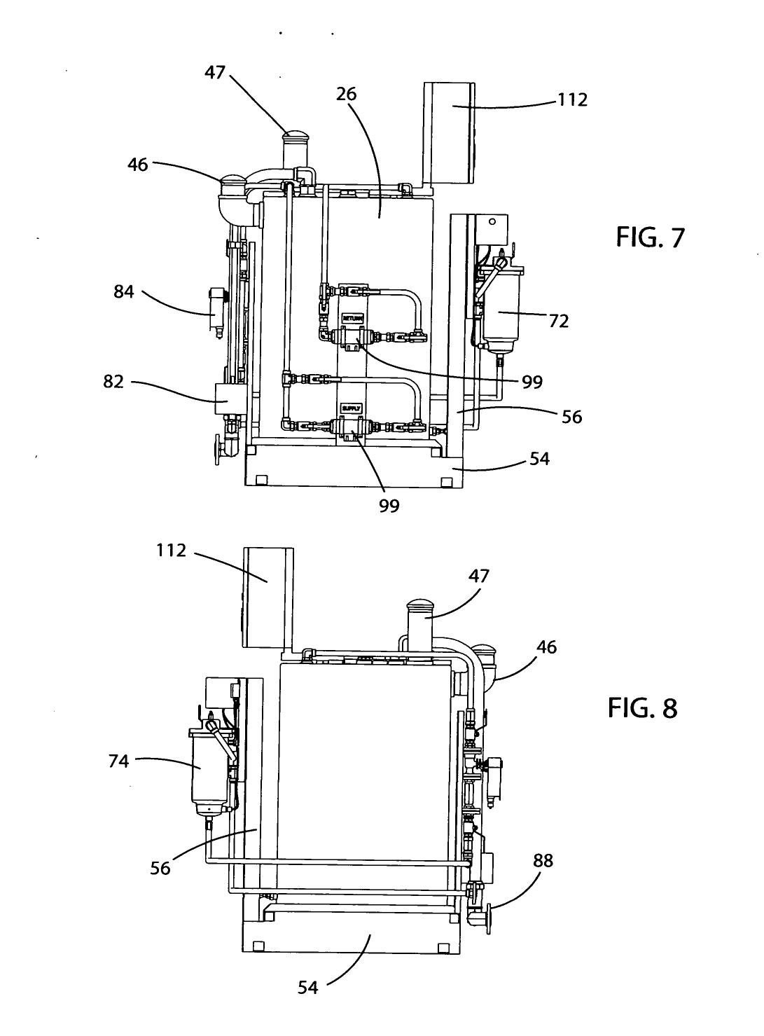

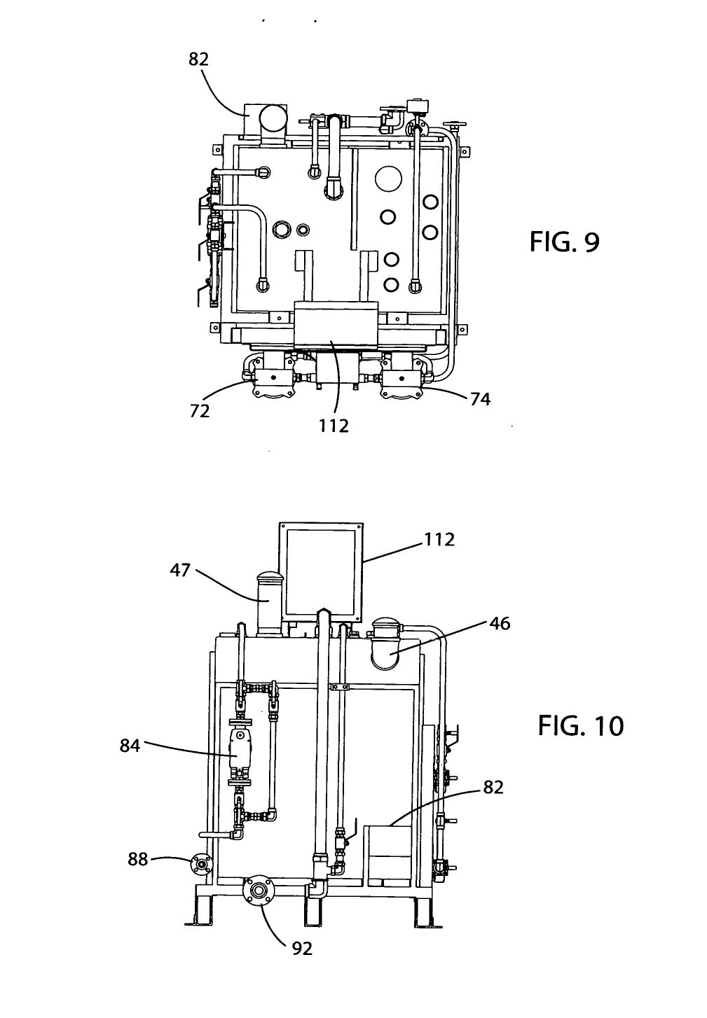

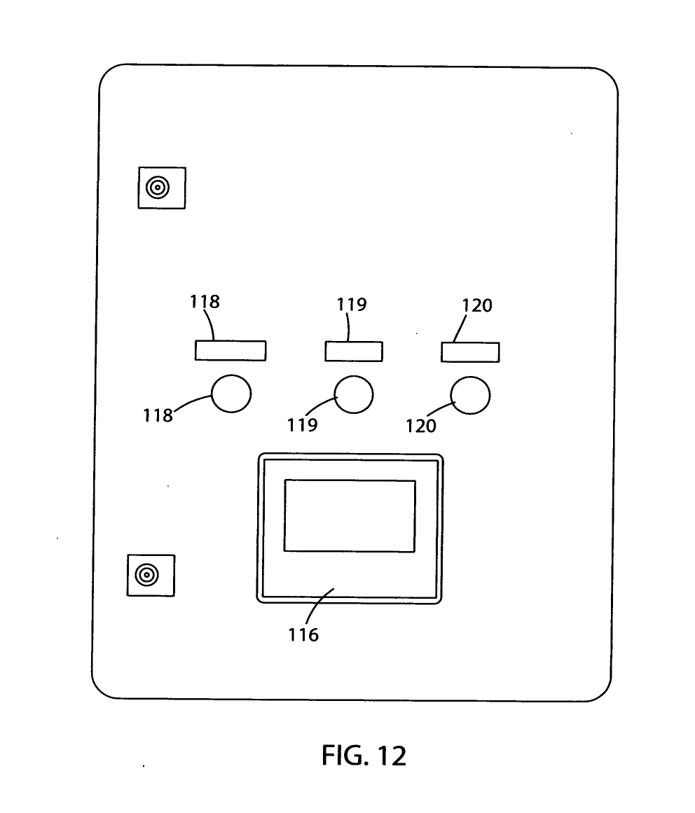

The best mode and preferred embodiment of the fully automated generator fuel system invention is shown by FIGS. 1-14. The present inventive generator fuel management assembly 20 comprises a double walled day tank 22 constructed with an outer front wall 24, outer side walls 26, 28 which are secured to the front outer wall 24 and an outer rear wall 30 which is secured to the outer side walls 26, 28. A bottom wall 32 and a top panel 34 are mounted and secured to the outer front wall 24, outer side walls 26, 28 and the outer rear wall 30 and form a fuel chamber 36 holding the associated inner wall components. The bottom panel wall 32 is seated on skid frame 50. As shown in FIGS. 4 and 5, an inner bottom wall 132 having intersecting sloped panel sections 133 and 135 is secured to the inner side walls 126 and 128 with the panel sections 133 and 135 being sloped downward toward panel wall 32 at six to nine degrees, preferably seven degrees as shown in the phantom representation. Inner front wall 124, inner side walls 126, 123 and inner rear wall 130 are mounted in the fuel chamber 36.

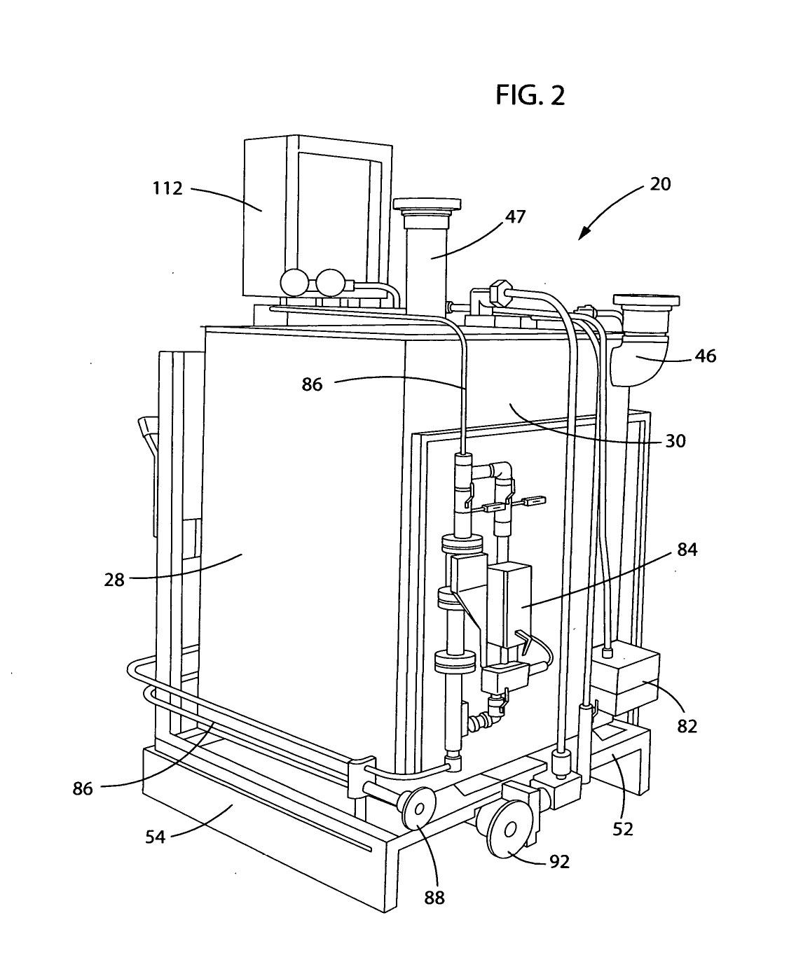

The tank side walls, front wall, and rear wall are spaced double walls which are constructed of carbon steel UL-142 listed, metal with a minimum thickness of 0.1345″ (10 ga.). The walls, top panel and bottom wall of the day tank 22 form a sealed chamber 36 having a preferred 150 US gallon nominal usable capacity (164.5 gallon total capacity) but can range from 100 to 1000 gallons for holding diesel fuel which is delivered to a generator (not shown). A half tank height forms the length of a stainless steel day tank fill tube 40 having an appropriate diameter extends into the chamber 36 along with an appropriately sized stainless steel engine supply drop tube 42 located at the rear of the chamber 36. Forward of drop tube 42, as shown in FIG. 5, a 23½ inch long, one inch wide stainless steel engine return drop tube 44 is positioned. A four inch interstitial emergency vent 46 extends rearward from the rear outer wall 30 as shown in FIGS. 2, 3 and 8 and an emergency interstitial vent 47 extends from the top panel 34. This vent discharges the chamber air into the atmosphere as the tank fills with fuel. The overall nominal dimensions are 63″w×51″d×75″h but vary with tank size.

A skid frame 50 is mounted to the day tank assembly 22 as shown in FIGS. 1-3. The skid frame 50 allows the entire assembly to be easily moved by fork lifts or similar vehicles. The skid frame 50 is constructed of a rectangular base member 52 and a plurality of support members 54 secured to base member 52. Each of the support members 54 has a planar base and is mounted to the bottom of base member 52 to provide a stable seating platform for the tank 22 as well as an entry point for the forks of a fork lift to enter to lift the frame 50 and associated tank 22 carrying the same to a desired location allowing portability of the assembly 20. A pair of upright support members 56 are connected together and braced by a horizontal support bar 58 secured to the distal ends of support members 56 which has their proximal ends mounted to the base member 52. The upright support members 56 hold a mounting plate 60 which holds an optional filter monitoring panel 62 and filter or filters 72 and 74. The optional filter monitoring panel 62 has indicator lights 63 showing a drain left filter light 64, a change active filter light 65, a drain right filter light 66 and a power on light 67.

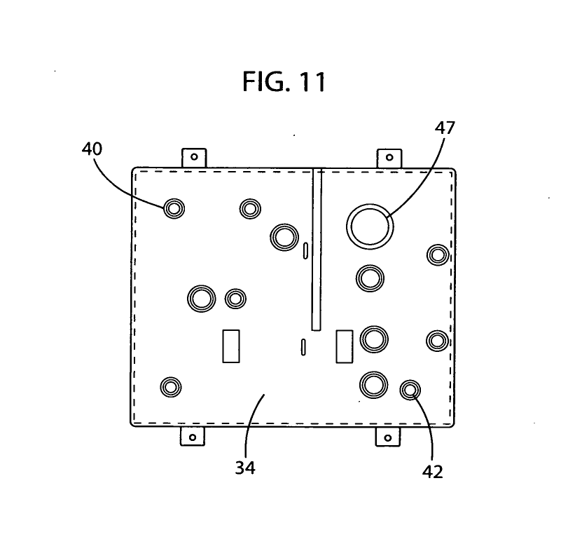

A filter assembly 70 as shown in FIGS. 1, 5, 11 and 13 comprises one or two three stage filter units 72 and 74 which are fluidly connected to each other by a stainless steel tubing assembly 78 having a manual valve 80 and 82 which can prevent fuel flow or allow fuel flow into the respective filter. When a single filter is used a bypass may be provided. When the valve handle is positioned perpendicular to the flow tube the conduit fuel flow is cut off and when the handle is positioned parallel to flow tube, the conduit fuel flow flows through the conduit. The high liquid flow rate for the filter assembly is 360 GPH. Each filter unit 72 and 74 has three stage filtration, a 2 micron pleated particulate filter, a coalescer plate for water and a fine particulate TEFLON® coated water separator. The filter additionally conducts water separation of both free and emulsified water to less than 12 PPM. Located at the bottom of each filter is a water drain valve 76 which can be used to empty the collector cup 75 on the bottom of each filter as shown in FIGS. 1 and 11.

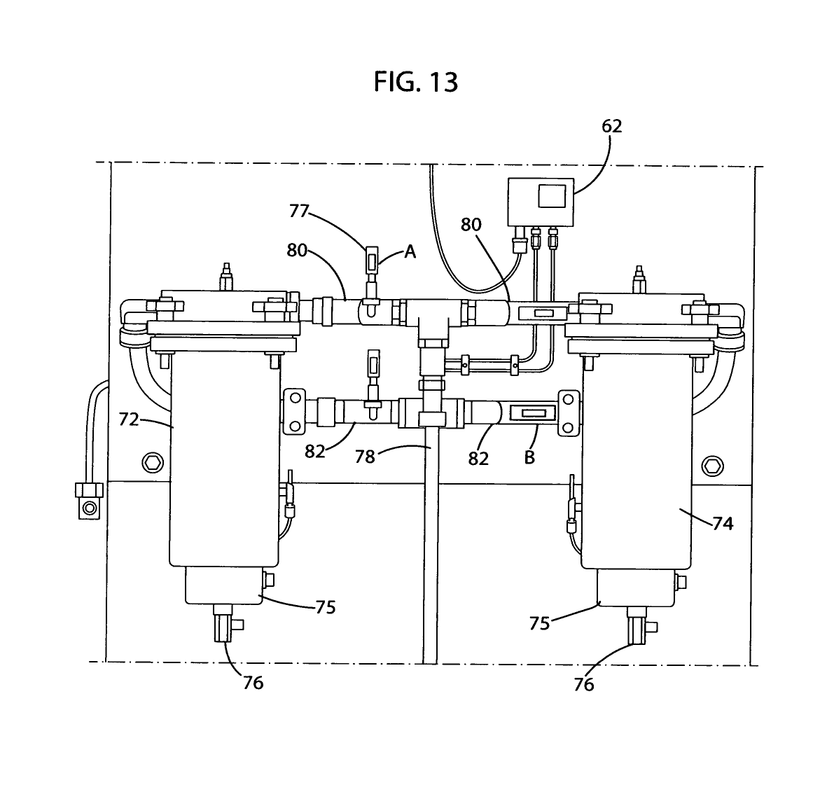

The filters 72 and 74 have a single filter flow rate of 10 GPM and as previously noted, provide three stage filtration for solids, articulate, tars, coalescing and separation. A pleated filter is mounted in each filter unit 72 and 74 to remove 1-micron particulate and separate water with 12 PPM efficiency. The filters 72 and 74 are preferably operated separately and are redundant. Each filter may be shut off manually by turning the valve arm 77 to a perpendicular position with respect to the axis of the fuel pipe as shown by the letter A in FIG. 13 or on by manually turning the valve arm 77 to a parallel position with regard to the axis of the fuel pipe as shown by the letter B in FIG. 13. A fuel inlet pipe 86 with mounting flange 88 is secured to a fuel supply fill pipe 98 as seen in FIG. 13. The fill pipe is connected to a desired filter assembly so that the incoming fuel can be filtered. An overfill return 90 and overfill pipe 94 with mounting flange 92 leads from the tank. The overfill return 90 is connected to a two inch stainless steel tubing 94 leading down the back of the tank 22 to the overfill return 90. Each filter is also provided with a water fuel sensor and has a digital PSI sensor with an LCD read-out and user programmable settings. Pressure differential on each side of the filter is measured and sensed by box 62 and when there is a pressure differential of more than 15 PSI, the filter should be changed.

The day tank assembly 22 is designed for installation in weather protected environments and is provided with a microprocessor 100 and touch screen 102 interface for system status indications and operations. These operations include but are not limited to fuel level monitoring, maintaining preset fuel levels, activating fuel replenishment, control valve operation, filtration monitoring including redundant inlet filtration with status monitoring, consumption monitoring with temperature and pulsation correction and network integration. The network accessible information includes, clogged filter, full water sump, current tank fuel level, fill valve position, high fuel level, low fuel level, critical low fuel level and various consumption information.

The front outer wall 24 of the tank 22 has a control panel assembly 110 and logic components mounted thereto as seen in FIGS. 1, 10 and 12. The control panel assembly 110 is an enclosed steel NEMA 3 rated box 112 with a hinged door 114. All electrical and logic control components are installed in the control box 112. All conduit and connectors to integrated equipment and sensors are brought into the control box 112. A color touch panel interface 116 can be optionally be mounted on the control panel front. A series of colored lights 118, 119 and 120 show, respectively, status good, warning and alarm. A programmable logic controller microprocessor 100 is mounted in the control box 112. The microprocessor based programmable logic control system has a touch-screen 116 which provides reliable system operation, with on-site reprogramming ability and networking capability. The touch-screen interface reduces operator complexity and potential failure points associated with multiple mechanical switches, indicator lights and relay based logic. The central control panel can additionally communicate with the facility building management system.

The rear outer wall 30 of the tank 22 as shown in FIGS. 2, 3 and 9 show the electrical junction box 82 which supplies power to the components, a control actuator 84 and the associated stainless steel tubing 85.

In operation diesel fuel is supplied to the tank container chamber 36 by an auxiliary fuel transfer system (not shown) which is fluidly connected to a main fuel tank. The supplied fuel is filtered by one of the three stage filter units 72 and 74, each being rated for 1 micron particulate removal and separation of both free and emulsified water with a 12 PPM efficiency. If the flow restriction in the active filter reaches a specified set point, the isolation valves 77 for the respective alternate filter should be manually opened as seen by letter B in FIG. 13. The isolation valves 77 for the clogged filter can then be manually closed as seen by the letter A in FIG. 13 allowing for a filter change with no interruption in the fuel supply. The separated water from the fuel is collected in the filter housing sump (now shown). When the separated water reaches a designated level in the sump sensors will provide local, lighted indication and remote monitoring output. Water can be manually drained from the sump through the sump drain valve.

The day tank 22 will automatically maintain fuel level in the tank between 88% to 100% full. When the fuel level drops below 88% full, the continuous level float sensor causes the day tank control system to actuate its fill valve and allow fuel to flow through fill pipe 86 through the respective filter 72 or 74 into the day tank fuel chamber 36. When the chamber 36 is 100% full, a float level switch causes the control system to close the valve shutting off the fuel flow. The fuel position is transmitted to the customer via an internet network to communicate that the tank 22 is filling. A pre-set 88% fill start point can be adjusted programmatically as desired by the end user.

At 103% full, a high level switch causes the day tank control system to alarm and disable the fill valve 104 from opening. Overfilled fuel can return automatically through the overfill drain 106 or manually by the siphon drain valve. The alarm is terminated when the fuel level in the day tank drops to 100%.

When the day tank is 62% full, a low level float sensor switch causes the day tank control system to alarm to warn the operator in the event of the failure of the auxiliary fuel transfer system to maintain fuel level at a minimum of 88% full in the day tank.

When the day tank is 10% full a critical low level float switch causes the day tank control system to alarm and to provide a remote monitoring point for shut down of the systems supplied by the day tank to prevent the suction of air into those systems.

Fuel supplied to and returning from the generator is measured by two positive displacement, screw-type flow meters 99 having an accuracy up to within 0.1% for each meter. Local digital differential flow calculation uses evaluation algorithms to eliminate errors from liquid temperature differences and pulsations and outputs a highly accurate measure of fuel consumed by the engine. Additional customer required inputs and outputs may be monitored, controlled, and reported by the control system. These inputs and outputs can include engine run information, atmospheric conditions and component status.

As indicated above, sensors are positioned at various points throughout the system. The primary function of the network of sensors is to detect fuel leaks in any part of the system including secondary containment pipes, vaults, tanks, and mechanical slabs. The sensors also indicate possible over fill and under fill conditions, spillage during fueling, and breaks and broken connections in pipes and other equipment. The MCP 12 alarm and report program will identify the exact location of such a problem in real time as indicated by this sensor and alarm system.

It should be understood that, while the description of the invention herein discloses a system in which fuel oil is being circulated, the invention can be utilized for numerous other gas or liquid products for delivery to end user equipment on demand.

A fully automated emergency generator fuel oil system according to the invention operates faster and more accurately than manually operated systems, allows adjustments to system components in real time to achieve optimum operating performance, significantly reduces labor and operating costs, decreases system failures, increases system life, and improves system reliability. An added benefit is that by collecting critical and sensitive system components in seismically resistant cabinets, a system is created having significantly improved resistance to seismic events.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A fuel tank assembly for an electrical generator comprising:
an enclosed walled tank with side walls, a front wall mounted to said side walls, a rear wall mounted to said side walls, a bottom wall and top wall mounted to said side walls, front wall and rear wall defining a central chamber adapted to receive diesel fuel;
a skid assembly mounted to at least one wall of said walled tank;
a plurality of sensors are positioned in said central chamber to determine the fuel level within said central chamber with said sensors being connected to means for automatically maintaining a desired fuel level within said central chamber;
a filtration assembly mounted to said fuel tank for receiving fuel and filtering said fuel, said filtration assembly fluidly communicating with said central chamber, and
a microprocessor assembly mounted on said fuel tank, said microprocessor assembly being connected to said sensors and filtration assembly to receive data from said sensors and filtration assembly and transmit said data to a user.

2. A fuel tank assembly as claimed in claim 1 wherein said side walls, said front wall, said rear wall and said bottom wall are double walls comprising an outer wall and an adjacent spaced inner wall with said bottom inner wall being formed of at least two angled sections extending downward toward said bottom wall.

3. A fuel tank assembly as claimed in claim 1 wherein said filtration assembly comprises a plurality of fluidly connected filter units which can be separately used, each filter unit having a capacity of one micron particulate removal and providing separation of both free and emulsified water with 12 PPM efficiency.

4. A fuel tank assembly as claimed in claim 1 wherein said sensors are float sensors with a high level fluid sensor and a low level fluid sensor.

5. A fuel tank assembly as claimed in claim 1 wherein said microprocessor assembly comprises a box, a computer, a touch screen and a control panels mounted to said box.

6. A fuel tank assembly as claimed in claim 1 wherein said microprocessor assembly has data storage memory, a touch screen and a control panel.

7. A fuel tank assembly as claimed in claim 2 wherein said inner bottom wall has a plurality of angled sections angled outward toward said bottom outer wall in a range from about 3° to about 15°.

8. A fuel tank assembly as claimed in claim 2 wherein said inner bottom wall has a plurality of angled sections angled toward said bottom outer wall in a range from about 6° degrees to about 9° degrees.

9. A fuel tank assembly as claimed in claim 1 wherein said skid assembly comprises a base frame, a plurality of support members secured to said base frame, an upright member secured to said base frame and a support plate mounted to said upright member.

10. A fuel tank assembly as claimed in claim 1 wherein said plurality of sensors include a plurality of float sensors positioned in said central chamber.

11. A fuel tank assembly as claimed in claim 1 wherein said fuel supplied to said tank is measured by an appositive displacement screw type flow meter.

12. A fuel tank assembly for an electrical generator comprising:
a double walled tank with a front wall, side walls, a rear wall, a bottom wall mounted to said front wall, said side walls and said rear wall and a top wall mounted to said front wall, said side walls and said rear wall defining an enclosed central chamber which can receive and hold diesel fuel;
said bottom wall being formed with at least two angled sections extending downward in said central chamber and engaging each other;
a support frame mounted to said tank, said support frame comprising a base frame, an upright frame section mounted to said base frame, and a support assembly mounted to said base frame;
a plurality of sensors mounted within said central chamber to determine the fuel level in said chamber and report said fuel levels to a microprocessor; said microprocessor being mounted to said support frame, an instrument panel housing mounted to at least one of said tank walls or said assembly frame,
a filtration assembly mounted to said double walled tank, said filtration assembly having fluid communication with said central chamber, and
said microprocessor being connected to said sensors and filtration assembly to receive data from said sensors and filtration assembly and transmit said data to a remote user.

13. A fuel tank assembly as claimed in claim 12 wherein said filtration assembly has a plurality of fluidly connected independently operating filters, each filter being rated for a one micron particulate removal and separation of both free and emulsified water, said water separated by said filter being collected in a filter housing sump.

14. A fuel tank assembly as claimed in claim 12 wherein said sensors automatically maintain fuel level between 88% to 100% within said tank chamber and trigger an alarm when said fuel level in said chamber reaches 10% full.

15. A fuel tank assembly as claimed in claim 12 wherein said fuel from said tank is supplied to an associated generator and said fuel returning from an associated generator is measured by separate positive displacement screw type flow meters.

16. A portable fuel tank assembly as claimed in claim 12 wherein said microprocessor has customized programmable logic control with on-site reprogramming capability and external communications capacity and is connected to the internet for transmission of data.

17. A fuel tank assembly as claimed in claim 12 wherein said day tank has operating indicator lights showing operation within a normal operating condition, a warning light and a critical alarm light.

18. A fuel tank assembly as claimed in claim 12 wherein said microprocessor is connected to the internet for transmission of data.

19. A portable fuel tank assembly for an electrical generator comprising:
a double walled tank with side walls, a front wall mounted to said side walls, a rear wall mounted to said side walls, a bottom wall mounted to said side walls and front and rear walls, a top wall mounted to said side walls and said front and rear walls, said top wall, side walls, rear wall and front wall and bottom wall defining an enclosed central chamber adapted to receive diesel fuel; a plurality of said walls including said bottom wall being a spaced double wall comprising an outer wall and an inner wall;
said inner bottom wall extending toward bottom outer wall at an angle;
a skid assembly mounted to said outer bottom wall;
a plurality of sensors mounted inside said central chamber from at least one of said walls to determine the fuel level of fuel held within said central chamber;
a filtration assembly mounted to said fuel tank and communicating with said central chamber, and
a microprocessor mounted on said fuel tank, said microprocessor being connected to said sensors and filtration assembly to receive data from said sensors and filtration assembly and transmit said data to a user.

20. A portable fuel tank assembly as claimed in claim 19 wherein said skid assembly comprises a base frame, a plurality of support members secured to said base frame, an upright member secured to said base frame and a support plate mounted to said upright member.
